(19) United States
(12) Patent Application Publication
(10) Pub. No.: US 2024/0063505 A1
(43) Pub. Date: Feb. 22, 2024

(54) OUTER CASING AND BATTERY MODULE

(71) Applicant: Panasonic Intellectual Property Management Co., Ltd., Osaka (JP)

(72) Inventors: HIROKI KAMITAKE, Aichi (JP); KAZUHIRO MORIOKA, Osaka (JP); SEIJI NISHIYAMA, Osaka (JP)

(21) Appl. No.: 18/496,298

(22) Filed: Oct. 27, 2023

Related U.S. Application Data
(63) Continuation of application No. PCT/JP2022/012116, filed on Mar. 17, 2022.

(30) Foreign Application Priority Data
May 25, 2021 (JP) 2021-087974

(51) Int. Cl. H01M 50/30; H01M 50/367; H01M 50/325; H01M 10/0562

(52) U.S. Cl. CPC H01M 50/394; H01M 50/367; H01M 50/325; H01M 10/0562; H01M 2300/008

(57) ABSTRACT

An outer casing includes a housing configured to house a battery, a gas adsorbing unit disposed outside the housing and including an adsorbent that can adsorb a first gas generated inside the housing, and a first valve configured to discharge the first gas from the gas adsorbing unit to outside of the outer casing. The first valve may be connected to the gas adsorbing unit. A battery module includes the outer casing and a battery disposed in the housing of the outer casing.

### BACKGROUND

### 1. Technical Field

The present disclosure relates to an outer casing for a battery, and a battery module.

### 2. Description of the Related Art

Japanese Unexamined Patent Application Publication No. 2020-202104 discloses a battery pack capable of detecting gas generated from battery cells with a sensor and adsorbing the gas using an adsorbent.

International Publication No. 2014/128909 discloses a battery pack equipped with an exhaust valve for discharging gas to the outside of a battery in order to prevent the increase in internal pressure of a battery case due to the gas generated from batteries.

### SUMMARY

It is desirable to further improve the safety of battery modules.

In one general aspect, the techniques disclosed here feature an outer casing including: a housing configured to house a battery; a gas adsorbing unit disposed outside the housing, the gas adsorbing unit including an adsorbent that can adsorb a first gas generated inside the housing; and a first valve configured to discharge the first gas from the gas adsorbing unit to outside of the outer casing.

According to the outer casing of the present disclosure, the safety of the battery module can be improved.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a schematic cross-sectional view illustrating the structure of an outer casing according to a first embodiment;

FIG. 2 is a schematic cross-sectional view illustrating the structure of an outer casing according to a second embodiment;

FIG. 3 is a schematic cross-sectional view illustrating the structure of an outer casing according to a third embodiment;

FIG. 4 is a schematic cross-sectional view illustrating the structure of an outer casing according to a fourth embodiment;

FIG. 5 is a schematic cross-sectional view illustrating the structure of an outer casing according to modification example 1;

FIG. 6 is a schematic cross-sectional view of an electrode material; and

FIG. 7 is a schematic cross-sectional view illustrating the structure of a battery.

### DETAILED DESCRIPTIONS

### Underlying Knowledge Forming Basis of the Present Disclosure

Japanese Unexamined Patent Application Publication No. 2020-202104 does not refer to the safety mechanism that acts in the event of the increase in the internal pressure of a battery pack due to hydrogen sulfide gas generated from battery cells. Thus, when the battery pack breaks due to the increased internal pressure, the issue of leakage of untreated hydrogen sulfide gas arises. Furthermore, the battery pack disclosed in Japanese Unexamined Patent Application Publication No. 2020-202104 is designed such that the package material of an adsorbent disposed in the same space as the battery cells is caused to break by a heating wire. Thus, there is an issue of the heat risk attributable to the heating wire for the battery cells.

According to International Publication No. 2014/128909, gas generated from batteries is discharged without being treated to the outside through a discharge valve directly installed in a battery case.

The inventors of the present disclosure has conducted extensive studies to improve the safety of the battery module. As a result, the inventors have arrived at an outer casing that includes a housing that can house batteries, a gas adsorbing unit that can adsorb gas generated from the batteries, and a valve that can discharge the gas treated in the gas adsorbing unit to the outside, in which the gas adsorbing unit is disposed outside the housing unit. When such an outer casing is used, the safety of the battery module can be improved.

Summary of one aspect of the present disclosure According to a first aspect of the present disclosure, an outer casing includes:
a housing configured to house a battery;
a gas adsorbing unit disposed outside the housing, the gas adsorbing unit including an adsorbent capable of adsorbing a first gas generated inside the housing; and
a first valve configured to discharge the first gas from the gas adsorbing unit to outside of the outer casing.

According to the first aspect, the first gas generated from the battery in the housing can be adsorbed by the adsorbent. The first gas is diluted as the first gas passes through the gas adsorbing unit and then is discharged to the outside of the outer casing. Thus, the safety of the battery module can be improved.

According to a second aspect of the present disclosure, for example, in the outer casing of the first aspect, the first valve may be connected to the gas adsorbing unit, or the first valve may be installed in a gas discharge channel extending from the gas adsorbing unit to the outside of the outer casing.

According to the second aspect, the first gas can be discharged to the outside of the outer casing through the first valve.

According to a third aspect of the present disclosure, for example, in the outer casing of the first or second aspect, the first valve may be disposed at an end portion of the gas adsorbing unit.

According to the third aspect, the first gas can be efficiently adsorbed by the adsorbent.

According to a fourth aspect of the present disclosure, for example, in the outer casing of any one of the first to third aspects, the gas adsorbing unit may be disposed at a bottom of the outer casing.

According to the fourth aspect, the first gas can be efficiently guided toward the gas adsorbing unit.

According to a fifth aspect of the present disclosure, for example, the outer casing of any one of the first to fourth aspects may further include a discharge space that is disposed between the housing and the gas adsorbing unit in a direction in which the first gas flows, and the first gas may be guided into the gas adsorbing unit through the discharge space.

According to the fifth aspect, the design flexibility of the outer casing can be improved.

According to a sixth aspect of the present disclosure, for example, in the outer casing of any one of the first to fifth aspects, the housing and the gas adsorbing unit may be in communication with each other.

According to the sixth aspect, the first gas generated from the batteries in the housing can be adsorbed by the adsorbent in the gas adsorbing unit.

According to a seventh aspect of the present disclosure, for example, the outer casing according any one of the first to fifth aspects may further include at least one communication channel that brings the housing and the gas adsorbing unit in communication with each other; and at least one second valve installed to the at least one communication channel.

According to the seventh aspect, the adsorbent is prevented from entering the housing even when the outer casing is shaken from the outside. Thus, the reliability of the outer casing is improved.

According to an eighth aspect of the present disclosure, for example, in the outer casing of the seventh aspect, the second valve may be disposed at a bottom of the housing.

According to the eighth aspect, the first gas can be efficiently discharged from the housing.

According to a ninth aspect of the present disclosure, in the outer casing of the seventh or eighth aspect, the at least one communication channel may include a plurality of communication channels, and the at least one second valve may include a plurality of second valves.

According to the ninth aspect, the first gas can be more efficiently guided toward the gas adsorbing unit due to the second valves.

According to a tenth aspect of the present disclosure, in the outer casing of any one of the seventh to ninth aspects, the first valve and the second valve may be pressure valves, and an opening pressure P1 of the first valve and an opening pressure P2 of the second valve may satisfy P1≥P2.

According to the tenth aspect, the first valve is prevented from opening at the same time the first gas is introduced into the gas adsorbing unit through the second valve. Thus, the first gas resides in the gas adsorbing unit for a relatively long time. Thus, the first gas can be efficiently adsorbed by the adsorbent.

According to an eleventh aspect of the present disclosure, for example, the outer casing of any one of the first to tenth aspects may further include a third valve for introducing a second gas to the housing.

According to the eleventh aspect, the second gas can be introduced into the housing from the outside of the outer casing through the third valve. As a result, the concentration of the first gas in the housing can be decreased.

According to a twelfth aspect of the present disclosure, for example, in the outer casing of the eleventh aspect, the third valve may be connectable to a container that stores the second gas.

According to the twelfth aspect, the second gas can be easily introduced into the housing from the outside of the outer casing through the third valve.

According to a thirteenth aspect of the present disclosure, for example, in the outer casing of the eleventh or twelfth aspect, the third valve may be disposed at an upper portion of the housing.

According to the thirteenth aspect, introduction of the second gas into the housing facilitates discharge of the first gas from the housing.

According to a fourteenth aspect of the present disclosure, for example, in the outer casing of any one of the eleventh to thirteenth aspects, the second gas may contain an inert gas.

According to the fourteenth aspect, the inert gas can be easily introduced into the housing. Introducing the inert gas into the housing not only can discharge the first gas to the outside but also can decrease the concentration of a gas, such as oxygen, susceptible to burning, or a combustible gas.

According to a fifteenth aspect of the present disclosure, for example, in the outer casing of any one of the first to fourteenth aspects, the first gas may contain a hydrogen sulfide gas.

According to a sixteenth aspect of the present disclosure, for example, in the outer casing of any one of the first to fifteenth aspects, the adsorbent may contain at least one selected from the group consisting of sodium hydroxide, sodium carbonate, sodium hydrogen carbonate, magnesium hydroxide, magnesium oxide, magnesium carbonate, potassium hydroxide, calcium hydroxide, and calcium carbonate.

According to the fifteenth and sixteenth aspects, the hydrogen sulfide gas can be effectively adsorbed by the adsorbent.

According to a seventeenth aspect of the present disclosure, for example, in the outer casing of any one of the first to sixteenth aspects, the first gas may contain at least one selected from the group consisting of a halogen gas and a halogen gas precursor. The halogen gas may contain at least one selected from the group consisting of F₂, Cl₂, Br₂, and I₂. The halogen gas precursor may contain a compound that generates hydrogen halide or hypohalous acid by hydrolysis.

According to an eighteenth aspect of the present disclosure, for example, in the outer casing of any one of the first to seventeenth aspects, the adsorbent may contain at least one selected from the group consisting of sodium sesquicarbonate, sodium thiosulfate, sodium aluminate, potassium oxide, potassium carbonate, and potassium hydrogen carbonate.

According to the seventeenth and eighteenth aspects, the halogen gas can be effectively adsorbed by the adsorbent.

According to a nineteenth aspect of the present disclosure, for example, in the outer casing of any one of the first to eighteenth aspects, the adsorbent may contain at least one selected from the group consisting of silica gel, zeolite, and activated carbon.

According to the nineteenth aspect, the first gas can be effectively adsorbed by the adsorbent.

According to a twentieth aspect of the present disclosure, a battery module includes:
the outer casing according to any one of the first to nineteenth aspects, and
a battery disposed at the housing of the outer casing.

According to the twentieth aspect, the safety of the battery module can be improved, and the energy density of the battery per volume can be improved.

According to a twenty-first aspect of the present disclosure, for example, in the battery module of the twentieth aspect, the battery may contain a sulfide solid electrolyte.

According to the twenty-first aspect, the output properties of the battery can be improved.

According to a twenty-second aspect of the present disclosure, for example, in the battery module of the twentieth or twenty-first aspect, the battery may contain a halide solid electrolyte, and the halide solid electrolyte may be represented by Formula 1 below:

Li_{α}M_{β}X_{γ} (1)
where α, β, and γ are each independently a value greater than 0, M includes at least one element selected from the group consisting of metalloids and metal elements other than Li, and X includes at least one element selected from the group consisting of F, Cl, Br, and I.

According to the twenty-second aspect, the output properties of the battery can be improved. In addition, since the thermal stability of the battery is improved, generation of toxic gas such as hydrogen sulfide can be reduced.

According to a twenty-third aspect of the present disclosure, an outer casing includes:
a battery housing configured to house a battery;
an adsorbent housing disposed outside the battery housing, the adsorbent housing being configured to house or to be filled with an adsorbent capable of adsorbing a first gas generated inside the battery housing; and
a first valve configured to discharge the first gas from the adsorbent housing to outside of the outer casing.

According to the twenty-third aspect, the first gas generated from the battery in the battery housing can be adsorbed by the adsorbent housed in or filling the adsorbent housing. The first gas is diluted as the first gas passes through the adsorbent housing and then is discharged to the outside of the outer casing. Thus, the safety of the battery module can be improved.

Hereinafter, the embodiments of the present disclosure are described with reference to the drawings.

### First Embodiment

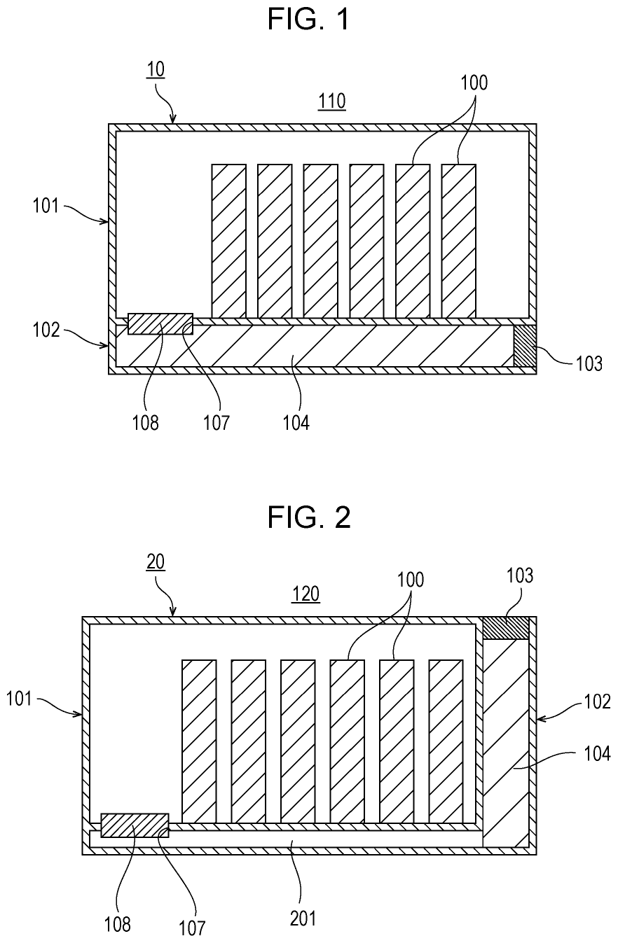

FIG. 1 is a schematic cross-sectional view illustrating the structure of an outer casing 10 according to a first embodiment. For the sake of simplicity, FIG. 1 illustrates a state in which multiple batteries 100 are housed in the outer casing 10. In other words, FIG. 1 illustrates a battery module 110 equipped with the outer casing 10 and batteries 100. The number of batteries 100 is usually more than one, but may be one.

The outer casing 10 includes a housing 101, a gas adsorbing unit 102, and a first valve 103. The housing 101 is designed to house at least one battery 100. The gas adsorbing unit (also referred to as an “adsorbent housing”) 102 has an adsorbent 104 that can adsorb first gas generated inside the housing 101, or the gas adsorbing unit houses or is filled with the adsorbent 104. The gas adsorbing unit 102 is located outside the housing 101. The first valve 103 discharges the first gas from the gas adsorbing unit 102 to the outside of the outer casing 10.

According to the aforementioned structure, first gas generated from the batteries 100 can be adsorbed by the adsorbent 104. When the internal pressure in the housing 101 has increased due to the first gas, the first gas is diluted as the first gas passes through the gas adsorbing unit 102 and then is discharged to the outside of the outer casing 10. Thus, breaking of the outer casing 10 by the first gas is avoided. Thus, the safety of the battery module 110 can be improved.

The first gas can be treated and detoxicated by the adsorbent 104 by appropriately choosing the adsorbent 104 according to the type of the first gas. As a result, leakage of the untreated first gas is suppressed.

The housing 101 has a space that can house the batteries 100.

The gas adsorbing unit 102 has a space that can house the adsorbent 104 or that can be filled with the adsorbent 104.

The outer casing 10 as a whole has, for example, a rectangular parallelepiped shape or a cubic shape. The housing 101 is adjacent to the gas adsorbing unit 102. The gas adsorbing unit 102 is combined or integrated with the housing 101. The outer casing 10 may be constituted by single casing or multiple casings. When the outer casing 10 is constituted by single casing, the inside of the outer casing 10 is divided into multiple spaces with partitions. The casing and the partitions that surround one space selected from the multiple spaces serve as the housing 101. The casing and the partitions that surround another one space selected from the multiple spaces serve as the gas adsorbing unit (may also be referred to as the adsorbent housing) 102. When the outer casing 10 is constituted by multiple casings, one casing selected from the multiple casings serves as the housing 101. Another casing selected from the multiple casings serves as the gas adsorbing unit 102. The casing constituting the gas adsorbing unit 102 may be detachably attachable to the casing constituting the housing 101. The outer casing 10 may be equipped with a lid for putting the batteries 100 in the housing 101 or removing the batteries 100 from the housing 101.

The material for the members constituting the housing 101 is not particularly limited. The material for the members constituting the housing 101 can be appropriately selected according to the structure of the batteries 100. The material for the members constituting the housing 101 may be a resin material or a metal material. A metal material has excellent heat conductivity. Thus, heat inside the housing 101 can be efficiently released to the outside. As a result, the temperature increase inside the housing 101 can be reduced. Thus, failure and performance degradation of the batteries 100 due to heat can be reduced.

The material for the members constituting the gas adsorbing unit 102 is not particularly limited. The material for the members constituting the gas adsorbing unit 102 can be appropriately selected according to the type of the adsorbent 104. The material for the members constituting the gas adsorbing unit 102 may be a resin material or a metal material. When the gas adsorbing unit 102 is combined or integrated with the housing 101, the material for the members constituting the housing 101 may be the same as the material for constituting the gas adsorbing unit 102.

The ratio of the volume of the gas adsorbing unit 102 to the total volume of the outer casing 10 may be smaller than the ratio of the housing 101 to the total volume of the outer casing 10.

The gas adsorbing unit 102 is at the bottom of the outer casing 10. The gas adsorbing unit 102 is combined or integrated with the housing 101 such that the gas adsorbing unit 102 is located at the bottom of the outer casing 10. When first gas is generated from the batteries 100, the specific gravity of the first gas is larger than the gas filling the housing 101. When the gas adsorbing unit 102 is at the bottom of the housing 101, the first gas can be efficiently and rapidly introduced into the gas adsorbing unit 102 by utilizing the difference in specific gravity between the first gas and the gas filling the housing 101.

In the present disclosure, “under” the housing 101 means being at a position lower than the housing 101 in the direction of gravitational force. “Above” the housing 101 means being at a position higher than the housing 101 in the direction of gravitational force. A “side” of the housing 101 means a position that is adjacent to the housing 101 or facing the housing 101 in a direction perpendicular to the direction of gravitational force.

The gas adsorbing unit 102 may be located under the housing 101. According to this structure also, the first gas can be efficiently introduced into the gas adsorbing unit 102 by utilizing the difference in specific gravity between the first gas and the gas filling the housing 101. In this embodiment, the entire gas adsorbing unit 102 is under the housing 101.

The first valve 103 is connected to the gas adsorbing unit 102. According to this structure, the first gas can be discharged to the outside of the outer casing 10 through the first valve 103.

In the present disclosure, an “end portion” of the gas adsorbing unit 102 means any one of two end portions of the gas adsorbing unit 102 in the first gas flow direction.

The first valve 103 is at an end portion of the gas adsorbing unit 102. According to this structure, the first gas travel distance in the gas adsorbing unit 102 can be easily increased. Thus, the first gas can be effectively adsorbed by the adsorbent 104. The first valve 103 may be attached to the lid of the gas adsorbing unit 102 or may itself be a lid.

The first valve 103 can be a valve that opens and closes according to the internal pressure in the gas adsorbing unit 102. For example, the first valve 103 may be a pressure valve that is activated when the internal pressure in the gas adsorbing unit 102 is larger than the outside atmospheric pressure of the outer casing 10, that is, activated at a positive pressure. The type of the pressure valve used as the first valve 103 may be any. Examples of the pressure valve include disk spring relief valves and rupture disks. A relief valve closes once a predetermined amount of first gas is released; thus, the outside air and the adsorbent 104 do not come into contact with each other beyond what is necessary. Thus, when a relief valve is used as the first valve 103, deterioration of the adsorbent 104 can be reduced.

The first valve 103 may be an electromagnetic valve that can be electronically controlled. When an electromagnetic valve is used as the first valve 103, the first valve 103 can be opened from a site remote from the outer casing 10. For example, the state of batteries 100 in operation is monitored, and the first valve 103 is opened in the event of abnormality such as the increase in internal pressure in the housing 101 due to generation of first gas. In this manner, the concentration of the first gas in the outer casing 10 can be decreased.

The outer casing 10 further includes a communication channel 107 and a second valve 108. The communication channel 107 brings the housing 101 and the gas adsorbing unit 102 in communication with each other. The second valve 108 is installed in the communication channel 107. According to this structure, the second valve 108 separates between the housing 101 and the gas adsorbing unit 102. In this manner, the adsorbent 104 is prevented from entering the housing 101 even when the outer casing 10 is shaken from the outside. Thus, the reliability of the outer casing 10 is improved.

Once the second valve 108 is open, the housing 101 and the gas adsorbing unit 102 are in communication with each other.

The second valve 108 is at the bottom of the housing 101. According to this structure, the first gas can be efficiently and rapidly discharged from the housing 101 by utilizing the difference in specific gravity between the first gas and the gas filling the housing 101.

The second valve 108 may be located under the housing 101. According to this structure also, the first gas can be efficiently discharged from the housing 101 by utilizing the difference in specific gravity between the first gas and the gas filling the housing 101.

For example, the second valve 108 may be a pressure valve that is activated when the internal pressure in the gas adsorbing unit 102 is larger than the outside atmospheric pressure of the outer casing 10, that is, activated at a positive pressure. Examples of the pressure valve are the same as the examples of the first valve 103 described above. In particular, when a rupture disk is used as the second valve 108, the size of the second valve 108 can be reduced.

The second valve 108 may be an electromagnetic valve that can be electronically controlled. When an electromagnetic valve is used as the second valve 108, the second valve 108 can be opened from a site remote from the outer casing 10. For example, the state of the batteries 100 in operation is monitored, and the second valve 108 is opened in the event of abnormality so that the first gas generated inside the outer casing 10 is introduced to the gas adsorbing unit 102. In this manner, the concentration of the first gas can be kept low from the early stage of generation of the first gas.

When the first valve 103 and the second valve 108 are both pressure valves, the opening pressure of the first valve 103 is defined as P1 and the opening pressure of the second valve 108 is defined as P2. Here, the relationship P1≥P2 may be satisfied. According to this structure, the first valve 103 and the second valve 108 are opened by a series of operations indicated below. Once first gas is generated from the batteries 100, the internal pressure in the housing 101 increases. When the internal pressure in the housing 101 exceeds the opening pressure P2, the second valve 108 opens. As a result, the first gas is discharged to the gas adsorbing unit 102. When the second valve 108 opens, the internal pressure in the housing 101 decreases. The first gas introduced into the gas adsorbing unit 102 is adsorbed by the adsorbent 104 and diluted. When the internal pressure of the gas adsorbing unit 102 increases due to the first gas introduced into the gas adsorbing unit 102 and exceeds the opening pressure P1, the first valve 103 opens. As a result, the first gas treated by the gas adsorbing unit 102 is discharged to the outside of the outer casing 10 through the first valve 103.

When P1≥P2, the first valve 103 is prevented from opening at the same time the first gas is introduced into the gas adsorbing unit 102 through the second valve 108. Thus, the first gas resides in the gas adsorbing unit 102 for a relatively long time. Thus, the first gas can be efficiently adsorbed by the adsorbent 104.

When the first valve 103 and the second valve 108 are both pressure valves, the opening pressure P1 of the first valve 103 and the opening pressure P2 of the second valve 108 can be set according to the rate in which the first gas is generated, the structure of the housing 101, and the structure of the gas adsorbing unit 102. An example of the opening pressure P1 of the first valve 103 is greater than or equal to 1 kPa and less than or equal to 1 MPa. An example of the opening pressure P2 of the second valve 108 is greater than or equal to 1 kPa and less than or equal to 1 MPa.

The communication channel 107 can be a through hole formed in a wall that separates the housing 101 and the gas adsorbing unit 102 or a tube attached to such a through hole.

The communication channel 107 brings the housing 101 and an end portion of the gas adsorbing unit 102 in communication with each other, and this end portion is different from the end portion where the first valve 103 is installed. According to this structure, the first gas travel distance in the gas adsorbing unit 102 can be easily increased. Thus, the first gas can be effectively adsorbed by the adsorbent 104.

The first gas may contain hydrogen sulfide gas.

The first gas may contain at least one selected from the group consisting of halogen gas and halogen gas precursors. The halogen gas may contain at least one selected from the group consisting of F₂, Cl₂, Br₂, and I₂. A halogen gas precursor is a compound that generates hydrogen halide or hypohalous acid by hydrolysis.

In the present disclosure, the “adsorbent” is a generic name of a material that adsorbs a particular chemical substance by chemical adsorption or physical adsorption. The type of the adsorbent 104 is not particularly limited. The adsorbent 104 can be appropriately selected according to the type of the first gas or the material for the gas adsorbing unit 102.

The form of the adsorbent 104 is not particularly limited. Examples of the form of the adsorbent 104 include a liquid, a solid, a slurry containing a powder and a liquid, and a semi-solid gel. The form of the adsorbent 104 can be appropriately selected according to the conditions such as the structure of the gas adsorbing unit 102, the type of the first gas, and the rate in which the first gas is adsorbed.

The adsorbent 104 may contain at least one selected from the group consisting of sodium hydroxide, sodium carbonate, sodium hydrogen carbonate, magnesium hydroxide, magnesium oxide, magnesium carbonate, potassium hydroxide, calcium hydroxide, and calcium carbonate. Such an adsorbent 104 can efficiently adsorb acidic gas generated from the batteries 100, in particular, hydrogen sulfide gas.

The adsorbent 104 may contain at least one selected from the group consisting of sodium sesquicarbonate (Na₂CO₃NaHCO₃·2H₂O), sodium thiosulfate, sodium aluminate, potassium oxide, potassium carbonate, and potassium hydrogen carbonate. Such an adsorbent 104 can efficiently adsorb halogen gas generated from the batteries 100.

The adsorbent 104 may contain at least one selected from the group consisting of silica gel, zeolite, and activated carbon. Such an adsorbent 104 can efficiently adsorb the first gas generated from the batteries 100.

The loading of the adsorbent 104 in the gas adsorbing unit 102 on a volume density basis may be greater than or equal to 1% and less than 99.5%, or may be greater than or equal to 20% and less than 90%. The proportion in which the gas adsorbing unit 102 is filled with the adsorbent 104 on a volume density basis may be greater than or equal to 30% or may be less than 90%. According to this feature, the gas adsorption efficiency can be improved while maintaining the gas permeability of the gas adsorbing unit 102.

The internal pressure in the housing 101 may be less than or equal to atmospheric pressure, or vacuum. When the internal pressure in the housing 101 is less than or equal to atmospheric pressure, or vacuum, a predetermined amount of the first gas can be stored in the housing 101 in the event of generation of the first gas from the batteries 100. Thus, the safety of the battery module 110 can be further improved.

The housing 101 may contain at least one selected from the group consisting of a gas, a liquid, and a solid. The gas may contain an inert gas that reduces the risk of the batteries 100 igniting. Examples of the inert gas include nitrogen, carbon dioxide, and rare gas including argon. According to these features, the safety of the battery module 110 can be further improved.

The type of the liquid is not particularly limited. The liquid can be selected according to the structure of the batteries 100 and the material for the outer casing 10 including the housing 101. Furthermore, the liquid may further contain a fire extinguishing agent that reduces the risk of the batteries 100 igniting. According to this feature, the safety of the battery module 110 can be further improved.

The type of the solid is not particularly limited. The solid can be selected according to the structure of the batteries 100 and the material for the outer casing 10 including the housing 101. The form of the solid may be powder from the viewpoint of gas permeability.

In the example illustrated in FIG. 1, the gas adsorbing unit 102 is at the bottom of the outer casing 10. The second valve 108 is at the bottom of the housing 101. The first valve 103 is at an end portion of the gas adsorbing unit 102. However, the installation positions of the gas adsorbing unit 102, the second valve 108, and the first valve 103 are not limited to these. The gas adsorbing unit 102 may be disposed at in upper portion of the outer casing 10, at the bottom of the outer casing 10, or at the side of the outer casing 10. The second valve 108 may be disposed at the upper portion of the housing 101, at the bottom of the housing 101, or at the side of the housing 101. The first valve 103 may be installed at a site other than the end portion of the gas adsorbing unit 102. The positions of the gas adsorbing unit 102, the first valve 103, and the second valve 108 can be appropriately selected according to the positional relationship with the batteries 100, the specific gravity of the first gas, etc.

Other embodiments will now be described. The common elements between the first embodiment and other embodiments are denoted by the same reference signs, and the descriptions therefor may be omitted. The descriptions related to these embodiments are interchangeable unless there are technical inconsistencies. The embodiments may be combined mutually unless there are technical inconsistencies.

### Second Embodiment

A second embodiment will now be described with reference to FIG. 2. FIG. 2 is a schematic cross-sectional view illustrating the structure of an outer casing 20 according to a second embodiment. As with FIG. 1, FIG. 2 illustrates a state in which multiple batteries 100 are housed in the outer casing 20. In other words, FIG. 2 illustrates a battery module 120.

In the present disclosure, the “first gas flow direction” means a direction in which the first gas travels from the housing 101 toward the gas adsorbing unit 102.

The outer casing 20 of this embodiment includes a discharge space 201 between the housing 101 and the gas adsorbing unit 102 in the first gas flow direction. Thus, the first gas generated inside the housing 101 is guided into the gas adsorbing unit 102 through the discharge space 201.

According to this structure also, first gas generated from the batteries 100 can be adsorbed by the adsorbent 104. When the internal pressure in the housing 101 has increased due to the first gas, the first gas is diluted as the first gas passes through the gas adsorbing unit 102 and then is discharged to the outside of the outer casing 20. Thus, breaking of the outer casing 20 by the first gas is avoided. Thus, the safety of the battery module 120 can be improved. Furthermore, since there is a discharge space 201 between the housing 101 and the gas adsorbing unit 102, the position of the gas adsorbing unit 102 can be adjusted, and thus the design flexibility of the outer casing 20 is improved. As a result, a structure appropriate for the installation space can be imparted to the outer casing 20.

The outer casing 20 as a whole has, for example, a rectangular parallelepiped shape or a cubic shape. The housing 101 is adjacent to the gas adsorbing unit 102 and the discharge space 201. The gas adsorbing unit 102 and the discharge space 201 are combined or integrated with the housing 101. The outer casing 20 may be constituted by single casing or multiple casings. When the outer casing 20 is constituted by single casing, the inside of the outer casing 20 is divided into multiple spaces with partitions. The casing and the partitions that surround one space selected from the multiple spaces serve as the housing 101. The housing and the partitions that surround another one space selected from the multiple spaces serve as the gas adsorbing unit 102 and the discharge space 201. When the outer casing 20 is constituted by multiple casings, one casing selected from the multiple casings serves as the housing 101. Another casing selected from the multiple casings serves as the gas adsorbing unit 102 and the discharge space 201. The casing constituting the gas adsorbing unit 102 and the discharge space 201 may be detachably attachable to the casing constituting the housing 101. The outer casing 20 may be equipped with a lid for putting the batteries 100 in the housing 101 or removing the batteries 100 from the housing 101.

When the outer casing 20 is constituted by multiple casings, the material for the members constituting the casing that constitutes the gas adsorbing unit 102 and the discharge space 201 is not particularly limited. The material for the members constituting the housing may be a resin material or a metal material. When the gas adsorbing unit 102 and the discharge space 201 are combined or integrated with the housing 101, the material for the members constituting the housing 101 may be the same as the material for the members constituting the gas adsorbing unit 102 and the discharge space 201.

In this embodiment, the gas adsorbing unit 102 is continuous with the discharge space 201. The discharge space 201 and the gas adsorbing unit 102 are in contact with each other in the first gas flow direction. In the first gas flow direction, the discharge space 201 is on the upstream side, and the gas adsorbing unit 102 is on the downstream side. The discharge space 201 is a space not filled with the adsorbent.

An air-permeable filter such as a mesh or film may be provided at the site where the discharge space 201 and the gas adsorbing unit 102 connect. According to this structure, the adsorbent 104 is prevented from entering the discharge space 201 from the gas adsorbing unit 102. The type of the air-permeable filter can be appropriately selected depending on the type of the first gas, the type of adsorbent 104, the rate of the first gas flowing from the discharge space 201 to the gas adsorbing unit 102, etc.

The ratio of the volume of the discharge space 201 to the total volume of the outer casing 20 may be smaller than the ratio of the volume of the gas adsorbing unit 102 to the total volume of the outer casing 20.

The discharge space 201 is at the bottom of the outer casing 20. In other words, the gas adsorbing unit 102 and the discharge space 201 are combined or integrated with the housing 101 such that the discharge space 201 is at the bottom of the outer casing 20. According to this structure, the first gas can be efficiently and rapidly introduced into the gas adsorbing unit 102 by utilizing the difference in specific gravity between the first gas and the gas filling the housing 101.

The discharge space 201 may be located under the housing 101. According to this structure also, the first gas can be efficiently introduced into the discharge space 201 by utilizing the difference in specific gravity between the first gas and the gas filling the housing 101. In this embodiment, the entire discharge space 201 is under the housing 101.

The gas adsorbing unit 102 is at the side of the outer casing 20. In this embodiment, the entire gas adsorbing unit 102 is at the side of the housing 101. Specifically, the gas adsorbing unit 102 and the discharge space 201 are combined or integrated with the housing 101 such that the gas adsorbing unit 102 is in contact with a side surface of the outer casing 20. The gas adsorbing unit 102 extends parallel in the perpendicular direction at the side of the outer casing 20.

In this embodiment, the first valve 103 is in an upper end portion of the gas adsorbing unit 102. According to this structure, the first gas travel distance in the gas adsorbing unit 102 can be easily increased. Thus, the first gas can be effectively adsorbed by the adsorbent 104.

In this embodiment, the communication channel 107 brings the housing 101 and the discharge space 201 in communication with each other. Once the second valve 108 is opened, the housing 101 and the discharge space 201 are in communication with each other.

In this embodiment, the communication channel 107 can be a through hole formed in a wall that separates the housing 101 and the discharge space 201 or a tube attached to such a through hole.

In the present disclosure, an “end portion” of the discharge space 201 means any one of two end portions of the discharge space 201 in the first gas flow direction.

In this embodiment, the communication channel 107 brings the housing 101 and an end portion of the discharge space 201 in communication with each other, and this end portion is different from the end portion in contact with the gas adsorbing unit 102. According to this structure, the first gas travel distance in the gas adsorbing unit 102 can be easily increased. Thus, the first gas can be effectively adsorbed by the adsorbent 104.

In the example illustrated in FIG. 2, the discharge space 201 is at the bottom of the outer casing 20. The gas adsorbing unit 102 is at the side of the outer casing 20. The second valve 108 is at the bottom of the housing 101. The first valve 103 is at an end portion of the gas adsorbing unit 102. However, the installation positions of the discharge space 201, the gas adsorbing unit 102, the second valve 108, and the first valve 103 are not limited to these. The discharge space 201 may be disposed at the upper portion of the outer casing 20, at the bottom of the outer casing 20, or at the side of the outer casing 20. The gas adsorbing unit 102 may be disposed at the upper portion of the outer casing 20, at the bottom of the outer casing 20, or at the side of the outer casing 20. The second valve 108 may be disposed at the upper portion of the housing 101, at the bottom of the housing 101, or at the side of the housing 101. The first valve 103 may be installed at a site other than the end portion of the gas adsorbing unit 102. The positions of the discharge space 201, the gas adsorbing unit 102, the first valve 103, and the second valve 108 can be appropriately selected according to the positional relationship with the batteries 100, the specific gravity of the first gas, etc.

### Third Embodiment

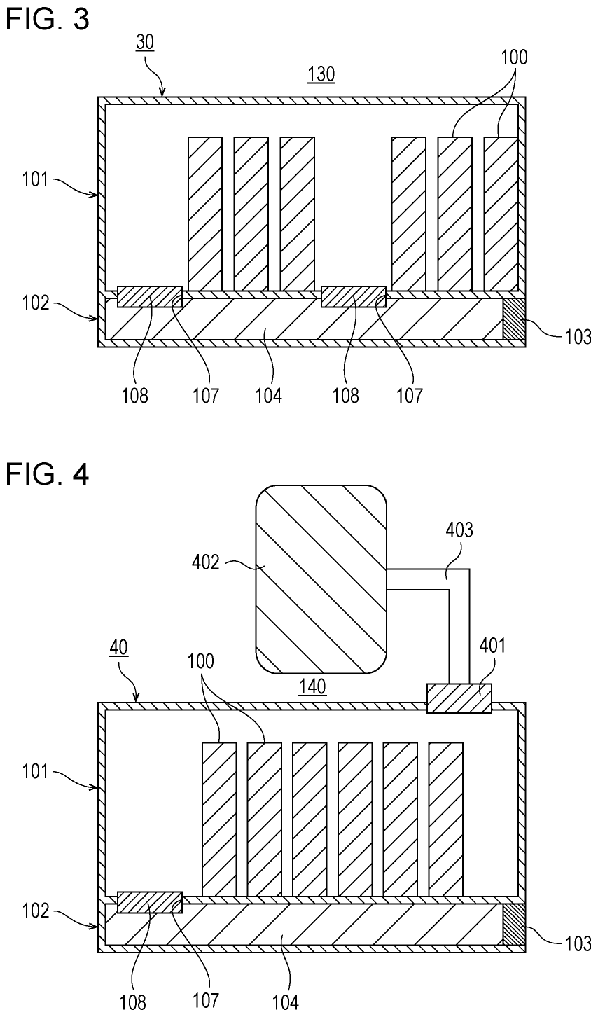

A third embodiment will now be described with reference to FIG. 3. FIG. 3 is a schematic cross-sectional view illustrating the structure of an outer casing 30 according to a third embodiment. As with FIGS. 1 and 2, FIG. 3 illustrates a state in which multiple batteries 100 are housed in the outer casing 30. In other words, FIG. 3 illustrates a battery module 130.

The outer casing 30 of this embodiment includes multiple communication channels 107 and multiple second valves 108 installed to the respective communication channels 107.

According to this structure also, first gas generated from the batteries 100 can be adsorbed by the adsorbent 104. When the internal pressure in the housing 101 has increased due to the first gas, the first gas is diluted as the first gas passes through the gas adsorbing unit 102 and then is discharged to the outside of the outer casing 30. Thus, breaking of the outer casing 30 by the first gas is avoided. Thus, the safety of the battery module 130 can be improved. Since multiple second valves 108 are provided, the first gas can be more efficiently guided toward the gas adsorbing unit 102.

When a large quantity of first gas is generated inside the housing 101 within a short period of time, it is desirable to quickly discharge the first gas from the housing 101 to the gas adsorbing unit 102 to moderate the sharp increase in internal pressure in the housing 101. When the battery module 130 is equipped with multiple second valves 108, there are more gas discharge channels leading to the gas adsorbing unit 102. Thus, the first gas can be quickly discharged to the gas adsorbing unit 102. Furthermore, even if some of the second valves 108 fail due to unexpected trouble, the function of the outer casing 30 is maintained by the rest of the second valves 108. Thus, the safety of the battery module 130 can be secured.

The second valves 108 are at the bottom of the housing 101. According to this structure, the first gas can be efficiently and rapidly discharged from the housing 101 by utilizing the difference in specific gravity between the first gas and the gas filling the housing 101.

At least one of the second valves 108 may be located at the bottom of the housing 101. According to this structure also, the first gas can be efficiently and rapidly discharged from the housing 101.

The second valves 108 may be located under the housing 101. According to this structure also, the first gas can be efficiently discharged from the housing 101 by utilizing the difference in specific gravity between the first gas and the gas filling the housing 101.

### Fourth Embodiment

A fourth embodiment will now be described with reference to FIG. 4. FIG. 4 is a schematic cross-sectional view illustrating the structure of an outer casing 40 according to a fourth embodiment. As with FIGS. 1 to 3, FIG. 4 illustrates a state in which multiple batteries 100 are housed in the outer casing 40. In other words, FIG. 4 illustrates a battery module 140.

The outer casing 40 of this embodiment is further equipped with a third valve 401 for introducing a second gas to the housing 101. The outer casing 40 is identical to the outer casing 10 of the first embodiment except for this additional third valve 401.

According to this structure also, first gas generated from the batteries 100 can be adsorbed by the adsorbent 104. When the internal pressure in the housing 101 has increased due to the first gas, the first gas is diluted as the first gas passes through the gas adsorbing unit 102 and then is discharged to the outside of the outer casing 40. Thus, breaking of the outer casing 40 by the first gas is avoided. According to this structure, the second gas can be introduced into the housing 101 from the outside of the outer casing 40 through the third valve 401. In this manner, the concentration of the first gas in the housing 101 can be decreased. Thus, the safety of the battery module 140 can be improved.

The third valve 401 can be connected to a container 402 for storing the second gas. According to this structure, the second gas can be easily introduced into the housing 101 from the container 402 through the third valve 401.

The third valve 401 is installed in the upper portion of the housing 101. According to this structure also, the first gas, which has a specific gravity larger than the gas filling the housing 101, can be more smoothly discharged from the housing 101 by introducing the second gas into the housing 101.

The third valve 401 may be located above the housing 101. According to this structure also, the first gas, which has a specific gravity larger than the gas filling the housing 101, can be smoothly discharged from the housing 101 by introducing the second gas into the housing 101.

An inflow channel 403 may be disposed between the container 402 and the third valve 401. According to this structure, the installation position of the container 402 can be adjusted. Thus, the container 402 can be placed at a site remote from the outer casing 40. In this embodiment, the inflow channel 403 is disposed between the container 402 and the third valve 401.

The outer casing 40 may be equipped with multiple third valves 401. According to this structure, when the batteries 100 are removed from the outer casing 40, the second gas can be introduced to the housing 101 through at least one of the third valves 401 and the gas filling the housing 101 can be discharged to the outside through the rest of the third valves 401. Here, the gas adsorbing unit 102 plays no part in the gas substitution inside the housing 101. Thus, there is no need to replace the adsorbent 104, and the batteries 100 can be safely recovered. Subsequently, the outer casing 40 can be reused. Thus, the running cost for the outer casing 40 can be reduced.

The inflow channel 403 may be designed to bring one outer casing 40 and one container 402 in communication with each other.

The inflow channel 403 may be designed to bring multiple outer casings 40 and one container 402 in communication with each other. For example, when there are more than one outer casings 40 equipped with third valves 401, one container 402 and multiple outer casings 40 can be connected to each other through at least one inflow channel 403. More than one inflow channels 403 may be provided, or the inflow channel 403 may have branching channels respectively connected to the multiple outer casings 40. According to this structure, the number of containers 402 can be reduced and the cost can be reduced.

The type of the valve used in the third valve 401 may be any. Examples of the type of valve used in the third valve 401 include ball valves, gate valves, butterfly valves, and diaphragm valves.

The open/close control of the third valve 401 may be performed manually, automatically, or electronically. When an electromagnetic valve is used as the third valve 401, the third valve 401 can be opened from a site remote from the outer casing 40. For example, the state of the batteries 100 in operation is monitored, and the third valve 401 is opened in the event of abnormality such as the increase in internal pressure in the housing 101 due to generation of the first gas. In this manner, the concentration of the first gas in the outer casing 40 can be rapidly decreased.

The second gas may contain an inert gas. According to this structure, the inert gas can be easily introduced into the housing 101. Introducing the inert gas into the housing 101 not only can discharge the first gas to the outside but also can decrease the concentration of a gas, such as oxygen, susceptible to burning, or a combustible gas. Thus, the safety of the battery module 140 can be improved.

Examples of the inert gas include nitrogen, carbon dioxide, and rare gas including argon. In this case, the safety of the battery module 140 can be further improved.

In the example illustrated in FIG. 4, the gas adsorbing unit 102 is at the bottom of the outer casing 40. The second valve 108 is at the bottom of the housing 101. The first valve 103 is at an end portion of the gas adsorbing unit 102. The third valve 401 is installed in the upper portion of the housing 101. However, the installation positions of the gas adsorbing unit 102, the second valve 108, the first valve 103, and the third valve 401 are not limited to these. The gas adsorbing unit 102 may be disposed at the upper portion of the outer casing 40, at the bottom of the outer casing 40, or at the side of the outer casing 40. The second valve 108 may be disposed at the upper portion of the housing 101, at the bottom of the housing 101, or at the side of the housing 101. The first valve 103 may be installed at a site other than the end portion of the gas adsorbing unit 102. The third valve 401 may be in the upper portion of the housing 101, at the bottom of the housing 101, or at the side of the housing 101. The positions of the gas adsorbing unit 102, the first valve 103, and the second valve 108, and the third valve 401 can be appropriately selected according to the positional relationship with the batteries 100, the specific gravity of the first gas, etc.

In the example illustrated in FIG. 4, the third valve 401 is installed at a site in the inflow channel 403 that connects to the housing 101. Alternatively, the third valve 401 may be located at a position in the inflow channel 403 other than where the housing 101 is connected. For example, the third valve 401 may be at a position where the inflow channel 403 connects to the container 402. The third valve 401 may be located in midway of the inflow channel 403.

### Modification Example 1

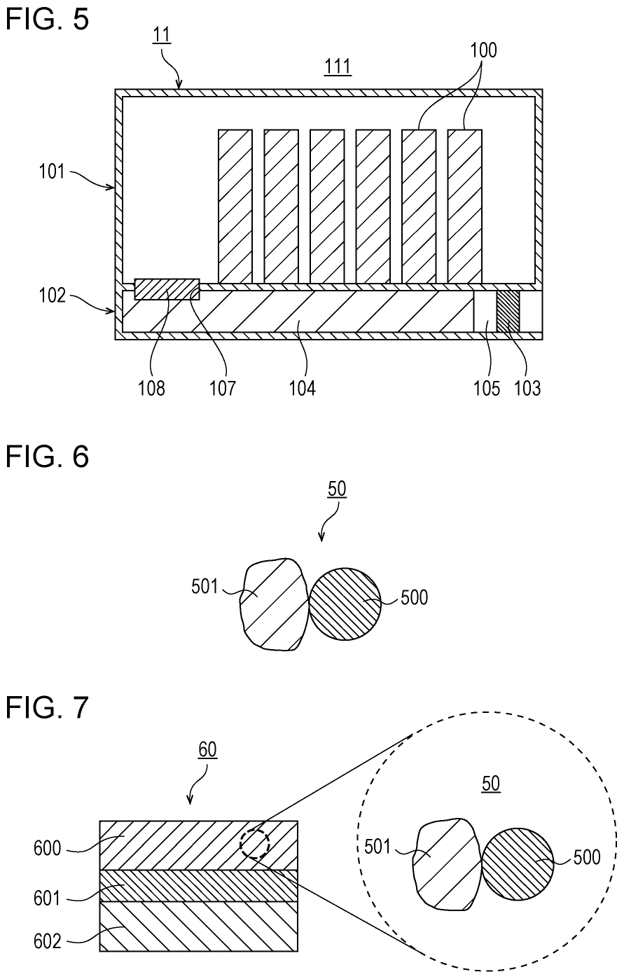

FIG. 5 is a schematic cross-sectional view illustrating the structure of an outer casing 11 according to modification example 1. As with FIG. 1, FIG. 5 illustrates a state in which multiple batteries 100 are housed in the outer casing 11. In other words, FIG. 5 illustrates a battery module 111.

The outer casing 11 has a gas discharge channel 105 extending from the gas adsorbing unit 102 to the outside of the outer casing 11. The first valve 103 is installed in the gas discharge channel 105.

According to this structure also, the first gas is diluted as the first gas passes through the gas adsorbing unit 102 and then is discharged to the outside of the outer casing 11. In other words, the contact between the first valve 103 and the gas adsorbing unit 102 is not an essential feature.

### Fifth Embodiment

A battery module of a fifth embodiment will now be described with reference to FIGS. 1 to 5. The descriptions that overlap those of the first to fourth embodiments and modification example 1 are omitted as appropriate.

The battery module of the fifth embodiment includes any one outer casing selected from those of the first to fourth embodiments and modification example 1, and batteries 100 placed in the housing 101. In other words, this battery module is a battery module 110, 120, 130, 140, or 111 illustrated in FIGS. 1 to 5.

According to this structure, the safety of the battery module can be improved. Furthermore, the energy density of the batteries 100 per volume can be improved.

The batteries 100 may be all-solid batteries.

In the present disclosure, the “sulfide solid electrolyte” refers to a solid electrolyte containing sulfur as anions.

In the battery module of the fifth embodiment, the batteries 100 may contain a sulfide solid electrolyte. According to this structure, the output density of the batteries 100 can be improved.

In the present disclosure, the “halide solid electrolyte” refers to a solid electrolyte containing a halogen as anions and being free of sulfur.

In the present disclosure, the “metalloids” are B, Si, Ge, As, Sb, and Te. The “metal elements” are all group 1 to 12 elements other than hydrogen in the periodic table and all group 13 to 16 elements other than B, Si, Ge, As, Sb, Te, C, N, P, O, S, and Se in the periodic table. In other words, the “metalloids” and the “metal elements” are a group of elements that can form cations in forming an inorganic compound with a halogen.

In the battery module of the fifth embodiment, the batteries 100 may contain a halide solid electrolyte. The halide solid electrolyte may be, for example, represented by Formula 1 below.

Li_{α}M_{β}Xγ (1)

Here, α, β, and γ are each a value greater than 0, M includes at least one element selected from the group consisting of metalloids and metal elements other than Li, and X includes at least one element selected from the group consisting of F, Cl, Br, and I.

According to this structure, the output properties of the batteries 100 can be improved. In addition, since the thermal stability of the batteries 100 is improved, generation of toxic gas such as hydrogen sulfide can be reduced.

Next, the batteries 100 housed in the outer casings described with reference to FIGS. 1 to 5 are described in detail.

FIG. 6 is a schematic cross-sectional view illustrating the structure of an electrode material 50 contained in the batteries 100.

The electrode material 50 contains an electrolyte 500 and an active material 501. The electrolyte 500 contains a solid electrolyte. According to this structure, the discharge voltage of the batteries can be improved.

The solid electrolyte contained in the electrolyte 500 may be a halide solid electrolyte.

The halide solid electrolyte can be a material containing Li, M, and X. In other words, the solid electrolyte contained in the electrolyte 500 may contain Li, M, and X. Here, M is at least one element selected from the group consisting of metalloids and metal elements other than Li. X is at least one element selected from the group consisting of F, Cl, Br, and I. According to these features, the ion conductivity of the solid electrolyte contained in the electrolyte 500 can be further improved. Thus, the output properties of the batteries can be further improved. In addition, thermal stability of the batteries can be improved. The halide solid electrolyte may be free of sulfur. When the halide solid electrolyte is free of sulfur, generation of hydrogen sulfide gas can be reduced.

The halide solid electrolyte contained in the electrolyte 500 may be, for example, represented by Formula 1 below.

Li_{α}M_{β}Xγ (1)

Here, α, β, and γ each independently represent a value greater than 0. M includes at least one element selected from the group consisting of metalloids and metal elements other than Li, and X includes at least one element selected from the group consisting of F, Cl, Br, and I. According to these features, the ion conductivity of the solid electrolyte contained in the electrolyte 500 can be improved. Thus, the output properties of the batteries can be improved. In addition, since the thermal stability of the batteries is improved, generation of toxic gas such as hydrogen sulfide can be reduced.

Examples of the halide solid electrolyte contained in the electrolyte 500 include Li₃YX₆, Li₂MgX₄, Li₂FeX₄, Li(Al,Ga,In)X₄, and Li₃(Al,Ga,In)X₆. Here, X includes at least one element selected from the group consisting of F, Cl, Br, and I.

In the present disclosure, the notation “(A,B,C)” in the formula means “at least one selected from the group consisting of A, B, and C”. For example, “(Al,Ga,In)” has the same meaning as the “at least one selected from the group consisting of Al, Ga, and In”.

The halide solid electrolyte contained in the electrolyte 500 may be, for example, a compound represented by the formula LiₐM_{b}Y_{c}X₆. Here, a+mb+3c=6, and c>0. X includes at least one element selected from the group consisting of F, Cl, Br, and I. M includes at least one element selected from the group consisting of metalloids and metal elements other than Li and Y. m represents a valence of M.

M may be at least one element selected from the group consisting of Mg, Ca, Sr, Ba, Zn, Sc, Al, Ga, Bi, Zr, Hf, Ti, Sn, Ta, and Nb, for example.

Specific examples of the halide solid electrolyte containing Y include Li₃YF₆, Li₃YCl₆, Li₃YBr₆, Li₃YI₆, Li₃YBrCl₅, Li₃YBr₃Cl₃, Li₃YBr₅Cl, Li₃YBr₅I, Li₃YBr₃I₃, Li₃YBrI₅, Li₃YClI₅, Li₃YCl₃I₃, Li₃YCl₅I, Li₃YBr₂Cl₂I₂, Li₃YBrCl₄I, Li_{2.7}Y_{1.1}Cl₆, Li_{2.5}Y_{0.5}Zr_{0.5}Cl₆, and Li_{2.5}Y_{0.3}Zr_{0.7}Cl₆.

According to this feature, the output properties of the batteries can be further improved.

The solid electrolyte contained in the electrolyte 500 may be a sulfide solid electrolyte.

Examples of the sulfide solid electrolyte that can be used include Li₂S—P₂S₅, Li₂S—SiS₂, Li₂SB₂S₃, Li₂S—GeS₂, Li_{3.25}Ge_{0.25}P_{0.75}S4, and Li₁₀GeP₂S₁₂. To these, LiX, Li₂O, MO_{q}, LiₚMO_{q}, or the like may be added. Here, X includes at least one element selected from the group consisting of F, Cl, Br, and I. M includes at least one element selected from the group consisting of P, Si, Ge, B, Al, Ga, In, Fe, and Zn. p and q each represent a natural number. At least one sulfide solid electrolyte selected from the aforementioned materials can be used.

According to this feature, the output properties of the batteries can be improved.

The solid electrolyte contained in the solid electrolyte layer 500 may be an oxide solid electrolyte, a polymer solid electrolyte, or a complex hydride solid electrolyte.

In the present disclosure, the “oxide solid electrolyte” refers to a solid electrolyte containing oxygen as main anions. The oxide solid electrolyte may contain, as anions other than oxygen, anions other than sulfur and halogens.

Examples of the oxide solid electrolyte include NASICON solid electrolytes such as LiTi₂(PO₄)₃ and element substitution products thereof, perovskite solid electrolytes based on (LaLi)TiO₃, LISICON solid electrolytes such as Li₁₄ZnGe₄O₁₆, Li₄SiO₄, LiGeO₄, and element substitution products thereof, garnet solid electrolytes such as Li₇La₃Zr₂O₁₂ and element substitution products thereof, Li₃N and H substitution products thereof, Li₃PO₄ and N substitution products thereof, and glass or glass ceramic based on a Li—B—O compound such as LiBO₂ or Li₃BO₃ doped with Li₂SO₄, Li₂CO₃, or the like.

The polymer solid electrolyte can be, for example, a compound between a polymer compound and a lithium salt. The polymer compound may have an ethylene oxide structure. The polymer compound having an ethylene oxide structure can contain a large amount of lithium salts. Thus, the ion conductivity can be further increased. Examples of the lithium salt that can be used include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. At least one lithium salt selected from the aforementioned lithium salts can be used.

Examples of the complex hydride solid electrolyte that can be used include LiBH₄—LiI and LiBH₄—P₂S₅.

In this embodiment, the active material 501 contains a material that has properties of occluding and releasing metal ions (for example, lithium ions). The active material 501 contains, for example, a positive electrode active material.

Examples of the positive electrode active material that can be used include lithium-containing transition metal oxides, transition metal fluorides, polyanion materials, fluorinated polyanion materials, transition metal sulfides, transition metal oxysulfides, and transition metal oxynitrides. Examples of the lithium-containing transition metal oxides include Li(Ni,Co,Al)O₂, Li(Ni,Co,Mn)O₂, and LiCoO₂. In particular, when a lithium-containing transition metal oxide is used as the positive electrode active material, the production cost can be reduced, and the average discharge voltage can be increased.

The positive electrode active material may be lithium nickel cobalt manganese oxide. For example, the positive electrode active material may be Li(Ni,CO,Mn)O₂.

According to this feature, the energy density of the batteries can be further increased.

The active material 501 may be coated with a coating material. A material having a low electronic conductivity can be used as the coating material. Examples of the coating material that can be used include oxide materials and oxide solid electrolytes.

Examples of the oxide materials that can be used include SiO₂, Al₂O₃, TiO₂, B₂O₃, Nb₂O₅, WO₃, and ZrO₂.

Examples of the oxide solid electrolyte that can be used as the coating material include Li—Nb—O compounds such as LiNbO₃, Li—B—O compounds such as LiBO₂ and Li₃BO₃, Li—Al—O compounds such as LiAlO₂, Li—Si—O compounds such as Li₄SiO₄, Li—Ti—O compounds such as Li₂SO₄ and Li₄Ti₅O₁₂, Li—Zr—O compounds such as Li₂ZrO₃, Li—Mo—O compounds such as Li₂MoO₃, Li-V-O compounds such as LiV₂O₅, and Li—W—O compounds such as Li₂WO₄.

The coating material may be an oxide solid electrolyte.

An oxide solid electrolyte has high ion conductivity. The oxide solid electrolyte has excellent high-potential stability. Thus, by using an oxide solid electrolyte as a coating material, the charge-discharge efficiency of the batteries can be further improved.

The coating material may be LiNbO₃.

LiNbO₃ has higher ion conductivity. LiNbO₃ has more excellent high-potential stability. Thus, by using LiNbO₃ as a coating material, the charge-discharge efficiency of the batteries can be further improved.

The coating material may contain a carbonate. A carbonate has low electronic conductivity. Thus, deterioration of the contact interface between the active material 501 and the electrolyte 500 can be reduced. Examples of the carbonate include lithium carbonate and lithium hydrogen carbonate.

The coating material may evenly cover the active material 501. In such a case, since the direct contact between the active material 501 and the electrolyte 500 is reduced, the side reaction of the solid electrolyte can be reduced. Thus, the charge-discharge efficiency of the batteries can be improved.

The coating material may cover some parts of the active material 501. The electronic conductivity between the particles of the active material 501 is improved when the particles of the active material 501 come into direct contact with each other in the parts not covered with the coating material. Thus, the batteries can be operated at high output.

The shape of the solid electrolyte contained in the electrolyte 500 is not particularly limited. The shape of the solid electrolyte may be, for example, a needle shape, a spherical shape, or an oval shape. For example, the solid electrolyte may have a particle shape.

When the solid electrolyte contained in the electrolyte 500 has a particle shape (for example, a spherical shape), the median diameter of the solid electrolyte may be less than or equal to 100 μm. When the median diameter of the solid electrolyte is less than or equal to 100 μm, the active material 501 and the electrolyte 500 can form an excellent dispersion state in the electrode. As a result, the charge-discharge characteristics of the battery are improved.

In the present disclosure, the “median diameter” refers to the particle diameter at which the accumulated volume in a volume-based particle size distribution is 50%. The volume-based particle size distribution is, for example, measured by a laser diffraction measuring instrument or an image analyzer.

The median diameter of the solid electrolyte contained in the electrolyte 500 may be less than or equal to 10 μm. When the median diameter of the solid electrolyte is less than or equal to 10 μm, the active material 501 and the electrolyte 500 can form an excellent dispersion state in the electrode.

The median diameter of the solid electrolyte contained in the electrolyte 500 may be smaller than the median diameter of the active material 501. In this manner, the electrolyte 500 and the active material 501 can form a more excellent dispersion state in the electrode.

The median diameter of the active material 501 may be greater than or equal to 0.1 μm and less than or equal to 100 μm. When the median diameter of the active material 501 is greater than or equal to 0.1 μm, the active material 501 and the electrolyte 500 can form an excellent dispersion state in the electrode. Thus, the charge-discharge characteristics of the battery are improved. When the median diameter of the active material 501 is less than or equal to 100 μm, lithium diffuses faster in the active material 501. Thus, the battery can operate at high output.

The median diameter of the active material 501 may be larger than the median diameter of the solid electrolyte contained in the electrolyte 500. In this manner, the active material 501 and the electrolyte 500 can form a more excellent dispersion state in the electrode.

In the electrode material 50, the particle of the electrolyte 500 and the particle of the active material 501 may be in contact with each other as illustrated in FIG. 6.

The electrode material 50 may contain multiple particles of the electrolyte 500 and multiple particles of the active material 501.

In the electrode material 50, the electrolyte 500 content and the active material 501 content may be the same or different.

FIG. 7 is a schematic cross-sectional view illustrating the structure of a battery 60. The battery 60 is one example of the batteries 100 housed in the outer casings described with reference to FIGS. 1 to 5. The battery 60 includes a positive electrode 600, an electrolyte layer 601, and a negative electrode 602. The electrolyte layer 601 is disposed between the positive electrode 600 and the negative electrode 602. At least one or the positive electrode 600 or the negative electrode 602 contains the electrode material 50 described above.

According to this structure, the discharge voltage of the battery 60 can be improved.

When the positive electrode 600 contains the electrode material 50, the volume ratio “v1:100−v1” of the active material 501 to the electrolyte 500 contained in the positive electrode 600 may satisfy 30≤v1≤95. Here, v1 represents the volume ratio of the active material 501 with respect to a total volume of 100 of the active material 501 and the electrolyte 500 contained in the positive electrode 600. When 30≤v1 is satisfied, a sufficient battery energy density can be secured. When v1≤95 is satisfied, the battery 60 can operate at high output.

The average thickness of the positive electrode 600 may be greater than or equal to 10 μm and less than or equal to 500 μm. When the average thickness of the positive electrode 600 is greater than or equal to 10 μm, a sufficient battery energy density can be secured. When the average thickness of the positive electrode 600 is less than or equal to 500 μm, the battery 60 can operate at high output.

The average thickness of the positive electrode 600 can be measured by the following method. A cross section of the positive electrode 600 is observed with a scanning electron microscope (SEM). The cross section is a section taken parallel in the layer stacking direction and includes the center of gravity of the positive electrode 600 in a plan view. In the obtained cross-sectional SEM image, twenty points are selected arbitrarily. The thickness of the positive electrode 600 is measured at the arbitrarily selected twenty points. The average of the measured values is deemed to be the average thickness.

The electrolyte layer 601 contains an electrolyte. The electrolyte is, for example, a solid electrolyte. In other words, the solid electrolyte layer 601 may contain a solid electrolyte layer. The materials mentioned in the fifth embodiments may be used as the solid electrolyte.

The average thickness of the electrolyte layer 601 may be greater than or equal to 1 μm and less than or equal to 300 μm. When the electrolyte layer 601 has an average thickness greater than or equal to 1 μm, short circuiting between the positive electrode 600 and the negative electrode 602 rarely occurs. When the average thickness of the electrolyte layer 601 is less than or equal to 300 μm, the battery 60 can operate at high output.

The method for measuring the average thickness of the positive electrode 600 described above can be applied to the method for measuring the average thickness of the electrolyte layer 601. The same applies to the negative electrode 602.

The negative electrode 602 contains, as a negative electrode active material, for example, a material that has properties of occluding and releasing metal ions (for example, lithium ions).

Examples of the negative electrode active material that can be used include metal materials, carbon materials, oxides, nitrides, tin compounds, and silicon compounds. The metal material may be a single metal. The metal material may be an alloy. Examples of the metal material include lithium metal and lithium alloys. Examples of the carbon materials include natural graphite, coke, graphitizing carbon, carbon fibers, spherical carbon, synthetic graphite, and amorphous carbon. The capacity density of the battery 60 can be improved by using silicon (Si), tin (Sn), a silicon compound, a tin compound, etc.

The negative electrode 602 may contain a solid electrolyte. According to this feature, the lithium ion conductivity inside the negative electrode 602 is improved. Thus, the battery can be operated at high output. The materials mentioned in the fifth embodiments may be used as the solid electrolyte.

When the solid electrolyte contained in the negative electrode 602 has a particle shape (for example, a spherical shape), the median diameter of the solid electrolyte may be less than or equal to 100 μm. When the median diameter of the solid electrolyte is less than or equal to 100 μm, the negative electrode active material and the solid electrolyte can form an excellent dispersion state in the negative electrode 602. As a result, the charge-discharge characteristics of the battery 60 are improved.

The median diameter of the solid electrolyte contained in the negative electrode 602 may be smaller than the median diameter of the negative electrode active material. In this manner, the negative electrode active material and the solid electrolyte can form an excellent dispersion state in the negative electrode 602.

The median diameter of the negative electrode active material may be greater than or equal to 0.1 μm and less than or equal to 100 μm. When the median diameter of the negative electrode active material is greater than or equal to 0.1 μm, the negative electrode active material and the solid electrolyte can form an excellent dispersion state in the negative electrode 602. As a result, the charge-discharge characteristics of the battery 60 are improved. When the median diameter of the negative electrode active material is less than or equal to 100 μm, lithium diffuses faster in the negative electrode active material. Thus, the battery 60 can operate at high output.

The median diameter of the solid electrolyte contained in the negative electrode 602 may be smaller than the median diameter of the negative electrode active material. In this manner, the solid electrolyte and the negative electrode active material can form an excellent dispersion state.

The volume ratio “v2:100−v2” of the negative electrode active material to the solid electrolyte contained in the negative electrode 602 may satisfy 30≤v2≤95. Here, v2 represents the volume ratio of the negative electrode active material with respect to a total volume of 100 of the negative electrode active material and the solid electrolyte contained in the negative electrode 602. When 30≤v2 is satisfied, a sufficient battery energy density can be secured. When v2≤95 is satisfied, the battery 60 can operate at high output.

The average thickness of the negative electrode 602 may be greater than or equal to 10 μm and less than or equal to 500 μm. When the average thickness of the negative electrode 602 is greater than or equal to 10 μm, a sufficient battery energy density can be secured. When the average thickness of the negative electrode 602 is less than or equal to 500 μm, the battery 60 can operate at high output.

At least one selected from the group consisting of the positive electrode 600, the electrolyte layer 601, and the negative electrode 602 may contain a binder to improve adhesion between particles. The binder is used to improve the binding property of the material constituting the electrode. Examples of the binder include polyvinylidene fluoride, polytetrafluoroethylene, polyethylene, polypropylene, aramid resin, polyamide, polyimide, polyamideimide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyether sulfone, hexafluoropolypropylene, styrene-butadiene rubber, and carboxymethylcellulose. A copolymer of two or materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene can also be used as the binder. A mixture of two or more selected from among the aforementioned materials may also be used as the binder.

At least one of the positive electrode 600 or the negative electrode 602 may contain a conductive additive to increase electron conductivity. Examples of the conductive additive that can be used include graphites such as natural and synthetic graphite, carbon blacks such as acetylene black and Ketjen black, conductive fibers such as carbon fibers and metal fibers, fluorinated carbon, metal powders such as aluminum, conductive whiskers such as zinc oxide and potassium titanate, conductive metal oxides such as titanium oxide, and conductive polymer compounds such as polyaniline, polypyrrole, and polythiophene. When a carbon conductive additive is used as the conductive additive, the cost can be reduced.

Examples of the shape of the battery 60 include a coin shape, a cylinder shape, a prism shape, a sheet shape, a button shape, a flat shape, and a multilayer shape.

The outer casing of the present disclosure can be used as, for example, an outer casing for a solid battery.

What is claimed is:

1. An outer casing comprising:
a housing configured to house a battery;
a gas adsorbing unit disposed outside the housing, the gas adsorbing unit including an adsorbent capable of adsorbing a first gas generated inside the housing; and
a first valve configured to discharge the first gas from the gas adsorbing unit to outside of the outer casing.

2. The outer casing according to claim 1, wherein the first valve is connected to the gas adsorbing unit, or
the first valve is installed in a gas discharge channel extending from the gas adsorbing unit to the outside of the outer casing.

3. The outer casing according to claim 1, wherein the first valve is disposed at an end portion of the gas adsorbing unit.

4. The outer casing according to claim 1, wherein the gas adsorbing unit is disposed at a bottom of the outer casing.

5. The outer casing according to claim 1, further comprising:
a discharge space that is disposed between the housing and the gas adsorbing unit in a direction in which the first gas flows,
wherein the first gas is guided into the gas adsorbing unit through the discharge space.

6. The outer casing according to claim 1, wherein the housing and the gas adsorbing unit are in communication with each other.

7. The outer casing according to claim 1, further comprising:
at least one communication channel that brings the housing and the gas adsorbing unit in communication with each other; and
at least one second valve installed to the at least one communication channel.

8. The outer casing according to claim 7, wherein the second valve is disposed at a bottom of the housing.

9. The outer casing according to claim 7, wherein the at least one communication channel includes a plurality of communication channels, and the at least one second valve includes a plurality of second valves.

10. The outer casing according to claim 7, wherein the first valve and the second valve are pressure valves, and an opening pressure P1 of the first valve and an opening pressure P2 of the second valve satisfy P1≥P2.

11. The outer casing according to claim 1, further comprising:
a third valve for introducing a second gas to the housing.

12. The outer casing according to claim 11, wherein the third valve is connectable to a container that stores the second gas.

13. The outer casing according to claim 11, wherein the third valve is disposed at an upper portion of the housing.

14. The outer casing according to claim 11, wherein the second gas contains an inert gas.

15. The outer casing according to claim 1, wherein the first gas contains a hydrogen sulfide gas.

16. The outer casing according to claim 1, wherein the adsorbent contains at least one selected from the group consisting of sodium hydroxide, sodium carbonate, sodium hydrogen carbonate, magnesium hydroxide, magnesium oxide, magnesium carbonate, potassium hydroxide, calcium hydroxide, and calcium carbonate.

17. The outer casing according to claim 1, wherein the first gas contains at least one selected from the group consisting of a halogen gas and a halogen gas precursor,
the halogen gas contains at least one selected from the group consisting of F₂, Cl₂, Br₂, and I₂, and
the halogen gas precursor contains a compound that generates a hydrogen halide or hypohalous acid by hydrolysis.

18. The outer casing according to claim 1, wherein the adsorbent contains at least one selected from the group consisting of sodium sesquicarbonate, sodium thiosulfate, sodium aluminate, potassium oxide, potassium carbonate, and potassium hydrogen carbonate.

19. The outer casing according to claim 1, wherein the adsorbent contains at least one selected from the group consisting of silica gel, zeolite, and activated carbon.

20. A battery module comprising:
the outer casing according to claim 1; and
a battery disposed in the housing of the outer casing.

21. The battery module according to claim 20, wherein the battery contains a sulfide solid electrolyte.

22. The battery module according to claim 20, wherein
the battery contains a halide solid electrolyte represented by Formula 1 below:
Li_{α}M_{β}X_{γ} (1)
where α, β, and γ are each independently a value greater than 0, M includes at least one element selected from the group consisting of metalloids and metal elements other than Li, and X includes at least one element selected from the group consisting of F, Cl, Br, and I.

23. An outer casing comprising:
a battery housing configured to house a battery;
an adsorbent housing disposed outside the battery housing, the adsorbent housing being configured to house or to be filled with an adsorbent capable of adsorbing a first gas generated inside the battery housing; and
a first valve configured to discharge the first gas from the adsorbent housing to outside of the outer casing.
